(19) United States
(12) Patent Application Publication
(10) Pub. No.: US 2009/0125199 A1
(43) Pub. Date: May 14, 2009

(54) Driving Force Control Device and Driving Force Control Method

(75) Inventor: Masato Kaigawa, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/886,840

(22) PCT Filed: Apr. 24, 2006
(86) PCT No.: PCT/IB2006/000979

§ 371 Date: Sep. 21, 2007

(30) Foreign Application Priority Data
Apr. 25, 2005 (JP) 2005-126808

(51) Int. Cl. B60W 30/18

(52) U.S. Cl. 701/54

(57) ABSTRACT

The invention relates to a driving force control device and method employed in a vehicle including a drive source and an automatic transmission which is connected to the drive source and which changes a speed ratio in a stepwise manner or continuously. With the control device and method, a first target driving force is set based on an operation amount of an accelerator pedal by a driver and a vehicle speed; a target throttle valve opening amount is set based on the operation amount of the accelerator pedal by the driver; a second target driving force is set based on the target throttle valve opening amount; a final target driving force is set by coordinating the first target driving force and the second target driving force with each other according to a predetermined coordination condition; and the drive source and the automatic transmission are controlled based on the final target driving force.

### BACKGROUND OF THE INVENTION

1. Field of the Invention

The invention relates generally to a driving force control device and method that controls driving force generated in a vehicle, and more specifically to such driving force control device and method employed in a vehicle including an automatic transmission.

2. Description of the Related Art

Japanese Patent Application Publication No. JP-A-2002-180860 describes a known technology where a target axle torque is calculated based on a vehicle speed and an accelerator pedal operation amount, and instructions indicating a target engine torque and a target shift speed based on the target axle torque are provided to respective control units.

Japanese Patent Application Publication No. JP-A-2002-187461 describes a driving force control device for a vehicle, which is provided to suppress an abrupt change in the engine torque during shifting, thereby preventing a shift shock when driving force is controlled in a vehicle including a stepped transmission. The driving force control device includes means for calculating a target driving force based on an operating state; means for calculating a delay speed ratio that changes, with a time lag, as the actual speed ratio of the transmission changes; means for calculating a target engine torque by dividing the target driving force by the actual speed ratio when the vehicle is running at a constant speed, and calculating the target engine torque by diving the target driving force by the delay speed ratio at least while the actual speed ratio changes; and means for controlling the engine torque such that the engine torque becomes equal to the target engine torque.

In recent years, systems embedded in a vehicle have become increasingly sophisticated and diversified. Accordingly, various instructions are provided to correct the target value (conventionally, the target throttle valve opening amount) that is initially calculated based on the input of the driver (accelerator pedal operation amount). Examples of such instructions include instructions from driver support systems such as the C/C system described above, and instructions from dynamic behavior control systems such as a traction control system. It is, therefore, necessary to coordinate the target value with these instructions.

In regard to this matter, the driving force demand-type configuration described in the above-mentioned publications is more advantageous than the throttle demand-type configuration. In the driving force demand-type configuration, the final target value expressed by the unit of driving force is set by determining the target value based on the accelerator pedal operation amount and coordinating this target value with various instruction values using the unit of driving force, and then the target engine torque (and target throttle valve opening amount) used for the engine control and the target shift speed used for the shift control are determined based on the final target value expressed by the unit of driving force. In contrast, in the throttle demand-type configuration, the target value, which is determined based on the accelerator pedal operation amount and which is expressed by the unit of throttle valve opening amount, is determined and coordinated with various instruction value. The driving force demand- type configuration is more advantageous, because the coordination appropriate for the instructions can be performed, and the systems can be controlled in a more appropriate integrated-manner. In addition, the driving force demand-type configuration is more advantageous, because it is not necessary to change the unit of physical quantity each time the coordination process is performed, which minimizes delays in communication.

However, in the driving force demand-type configuration, the target driving force is determined basically without taking a shifting operation into account. Accordingly, if the target driving force is gradually changed before and after shifting, during upshifting, the throttle valve opening amount rapidly increases in order to rapidly increase the target engine torque. On the other hand, the throttle valve opening amount rapidly decreases during downshifting. Such a state corresponds to a further depression or release of the accelerator pedal during a shifting operation by the driver. The driver may feel a sense of discomfort due to such a rapid increase/decrease in the throttle valve opening amount. Also, if a shifting operation is performed while the accelerator pedal is normally operated, a change in the engine torque (theoretically, a stepwise change) characteristically changes due to an influence of the inertia torque. With the driving force demand-type configuration, however, it is considerably difficult to realize a mode of determining the target driving force, in which a change in the engine torque during shifting can be compensated without bringing a sense of discomfort to the driver.

### SUMMARY OF THE INVENTION

It is an object of the invention to provide a driving force control device and method that uses both a driving force demand type configuration and a throttle demand type configuration as the situation demands, thereby reducing a sense of discomfort felt by a driver during shifting, etc.

A first aspect of the invention relates to a driving force control device that is used in a vehicle including a drive source and an automatic transmission which is connected to the drive source and which changes a speed ratio in a stepwise manner or continuously. The driving force control device includes first target driving force setting means for setting a first target driving force based on an operation amount of an accelerator pedal by a driver and a vehicle speed; target throttle valve opening amount setting means for setting a target throttle valve opening amount based on the operation amount of the accelerator pedal by the driver; second target driving force setting means for setting a second target driving force based on the target throttle valve opening amount; final target driving force setting means for setting a final target driving force by coordinating the first target driving force and the second target driving force with each other according to a predetermined coordination condition; and driving force control means for controlling the drive source and the automatic transmission based on the final target driving force..

A second aspect of the invention relates to a driving force control method employed in a vehicle including a drive source and an automatic transmission which is connected to the drive source and which changes a speed ratio in a stepwise manner or continuously. According to the driving force control method, a first target driving force is set based on an operation amount of an accelerator pedal by a driver and a vehicle speed; a target throttle valve opening amount is set based on the operation amount of the accelerator pedal by the driver; a second target driving force is set based on the target throttle valve opening amount; a final target driving force is set by coordinating the first target driving force and the second target driving force with each other according to a predetermined coordination condition; and the drive source and the automatic transmission are controlled based on the final target driving force.

In each of the first and second aspects, a higher priority may be given to the first target driving force than to the second target driving force, whereby the final target driving force is set to the first target driving force, when the vehicle starts running. In addition, a higher priority may be given to the second target driving force than to the first target driving force, whereby the final target driving force is set to the second target driving force, when the vehicle is running at a constant speed.

In each of the first and second aspects, a higher priority may be given to the first target driving force than to the second target driving force, whereby the final target driving force is set to the first target driving force, when a speed at which the accelerator pedal is operated is equal to or higher than a predetermined value. In addition, a higher priority may be given to the second target driving force than to the first target driving force, whereby the final target driving force is set to the second target driving force, when the speed at which the accelerator pedal is operated is lower than the predetermined value.

With the driving force control device and method according to the invention, it is possible to reduce a sense of discomfort felt by the driver during shifting, etc.

### BRIEF DESCRIPTION OF THE DRAWINGS

The features of the invention and advantages thereof, as well as the technical and industrial significance of this invention, will be better understood by reading the following detailed description of preferred embodiments of the invention, when considered in connection with the accompanying drawings, in which:

FIG. 1 illustrates the top view of a vehicle including a vehicle integrated-control apparatus in which a driving force control device according to the invention is embedded;

FIG. 2 illustrates the system diagram showing a vehicle integrated-control apparatus according to an embodiment of the invention;

FIG. 3 illustrates the flowchart of a target driving force calculation and coordination routine performed by a target driving force calculation portion of a P-DRM;

FIG. 4A illustrates the graph showing the relationship between an operation amount of an accelerator pedal and an accelerator angle pap;

FIG. 4B illustrates the graph showing the relationship between the operation amount of the accelerator pedal and the accelerator angle pap, which is obtained when a nonlinear- sensitivity-property compensation process according to the invention is performed;

FIG. 5 illustrates the graph showing an example of the three-dimensional map that defines the relationship among an accelerator angle, a wheel speed, and a target acceleration; and

FIG. 6 illustrates the two-dimensional map that defines the relationship between the accelerator angle and the target throttle valve opening amount.

### DETAILED DESCRIPTION OF THE EXAMPLE EMBODIMENTS

In the following description and the accompanying drawings, the invention will be described in more detail in terms of example embodiments. First, a vehicle including a vehicle integrated-control apparatus in which a driving force control device according to the invention is embedded will be schematically described.

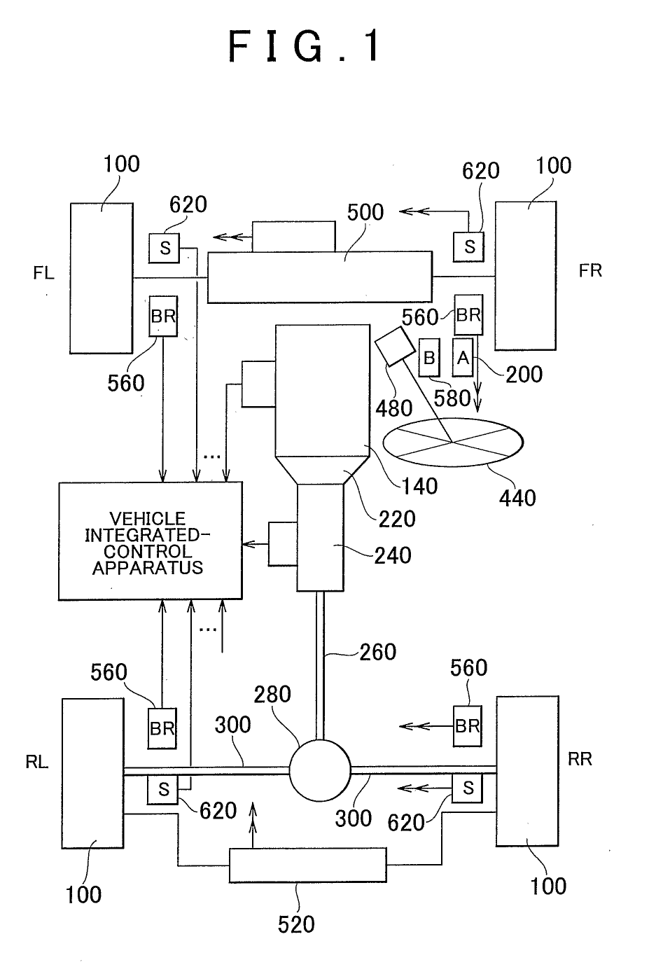

The vehicle is provided with right and left front wheels 100 and right and left rear wheels 100. In FIG. 1, “FR” denotes the right front wheel, “FL” denotes the left front wheel, “RR” denotes the right rear wheel, and “RL” denotes the left rear wheel.

The vehicle includes an engine 140 as a power source. The power source is not limited to an engine. An electric motor may be used as the sole power source. Alternatively, an engine and an electric motor may be used in combination as the power source. The power source for the electric motor may be a secondary battery or a fuel cell.

The operating state of the engine 140 is electrically controlled based on the operation amount of an accelerator pedal 200 (one of the input members operated by the driver to control the forward movement, backward movement, speed, or acceleration of the vehicle) by the driver. If necessary, the operating state of the engine 140 may be automatically controlled independently of the operation of the accelerator pedal 200 by the driver.

The engine 140 is electrically controlled by electrically controlling, for example, the opening amount of a throttle valve (not shown) (hereinafter, referred to as a “throttle valve opening amount”) provided in an intake manifold of the engine 140, the amount of fuel injected into a combustion chamber of the engine 140, or the angular position of an intake camshaft that adjusts the valve opening/closing timing.

The example vehicle is a rear-wheel drive vehicle where the right and left front wheels are the driven wheels and the right and left rear wheels are the drive wheels. Accordingly, the output shaft of the engine 140 is connected to the right and left rear wheels via a torque converter 220, a transmission 240, a propeller shaft 260, a differential gear unit 280, and a drive shaft 300 that rotates along with the rear wheels. The torque converter 220, the transmission 240, the propeller shaft 260, and the differential gear unit 280 are power transmission elements shared by the right and left rear wheels. However, the application of vehicle integrated-control apparatus according to the embodiment is not limited to rear-wheel drive vehicles. The vehicle integrated-control apparatus may be applied, for example, to front-wheel drive vehicles where the right and left front wheels are the drive wheels and the right and left rear wheels are the driven wheels. Also, the vehicle integrated-control apparatus may be applied to four-wheel drive vehicles where all the wheels are the drive wheels.

The transmission 240 is an automatic transmission. The automatic transmission electrically controls the speed ratio, based on which the speed of the engine 140 is converted into the rotational speed of the output shaft of the transmission 240. This automatic transmission may be either a stepped transmission or a continuously variable transmission (CVT).

The vehicle includes a steering wheel 440 operated by the driver. A steering reaction force supply device 480 electrically supplies the steering wheel 440 with a steering reaction force, that is, a reaction force corresponding to the operation of the steering wheel 440 performed by the driver (hereinafter, sometimes referred to as “steering”). The steering reaction force can be electrically controlled.

The orientation of the right and left front wheels, namely, the steering angle of the front wheels is electrically controlled by a front steering device 500. The front steering device 500 controls the steering angle of the front wheels based on the angle by which the driver has turned the steering wheel 440. If necessary, the front steering device 500 may automatically control the steering angle of the front wheels independently of the operation of the steering wheel 440 by the driver. In other words, the steering wheel 440 may be mechanically isolated from the right and left front wheels.

Similarly, the orientation of the right and left rear wheels, namely, the steering angle of the rear wheels is electrically controlled by a rear steering device 520.

The wheels 100 are provided with respective brakes 560 that are applied to suppress rotation of the wheels 100. The brakes 560 are electrically controlled based on the operation amount of a brake pedal 580 (one of the input members operated by the driver to control the forward movement, backward movement, speed, or acceleration of the vehicle) by the driver. If necessary, the wheels 100 may be individually and automatically controlled.

In the example vehicle, the wheels 100 are connected to the vehicle body (not shown) via respective suspensions 620. The suspension properties of each suspension 620 can be electrically controlled independently of the other suspensions 620.

The following actuators are used to electrically control the corresponding components described above:
(1) an actuator that electrically controls the engine 140;
(2) an actuator that electrically controls the transmission 240;
(3) an actuator that electrically controls the steering reaction force supply device 480;
(4) an actuator that electrically controls the front steering device 500;
(5) an actuator that electrically controls the rear steering device 520;
(6) actuators that electrically control the brakes 560; and
(7) actuators that electrically control the suspensions 620.

Only commonly used actuators are listed above. Whether all the actuators listed above are required depends on the specifications of the vehicles. Some vehicles do not include one or more actuators listed above. Alternatively, other vehicles may include other actuators, in addition to the actuators listed above, such as an actuator used to electrically control the ratio between the steering amount of the steering wheel 440 and the steered amount of the steered wheel (steering ratio), and an actuator used to electrically control a reaction force of the accelerator pedal 200. Accordingly, the invention is not limited to the particular actuator configurations mentioned above.

As shown in FIG. 1, the vehicle integrated-control apparatus that is mounted in the vehicle is electrically connected to the various actuators described above. A battery (not shown) serves as the electric power source for the vehicle integrated-control apparatus.

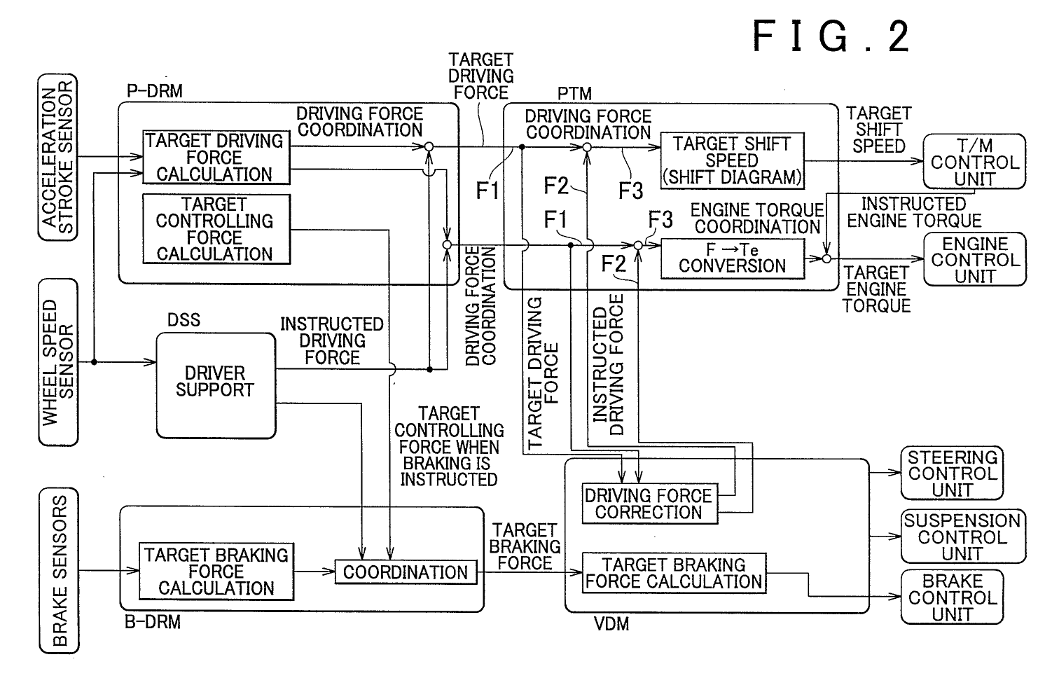

FIG. 2 illustrates the system diagram of the vehicle integrated-control apparatus according to the embodiment of the invention.

As in the case of a commonly used ECU (electronic control unit), each manager (and model) described below may be a microcomputer that includes, for example, ROM that stores control programs, RAM where results of calculations and the like are stored and the data can be retrieved and/or updated, a timer, a counter, an input interface, an output interface, and the like. In the following description, the control units are grouped by function, and referred, for example, to as a P-DRM, a VDM, and the like. However, the P-DRM, the VDM, and the like need not be configurations physically independent of each other. The P-DRM, the VDM, and the like may be configured integrally with each other using an appropriate software structure.

As shown in FIG. 2, at the highest level of the drive control system, a manager that functions as a driver's intention determining portion of the drive control system (hereinafter, referred to as a “P-DRM”: Power-Train Driver Model) is arranged. At the highest level of the drive control system, a driver support system (hereinafter, referred to as a “DSS”: Driver Support System) is arranged in parallel to the P-DRM.

At the level superior to the P-DRM, an acceleration stroke sensor is arranged. The acceleration stroke sensor produces an electric signal corresponding to the operation amount of the accelerator pedal 200, which directly reflects the input of the driver.

At the level superior to the DSS, wheel speed sensors are arranged. The wheel speed sensors are provided for the respective wheels 100. Each wheel speed sensor 100 outputs a pulse signal each time the wheel 100 rotates through a predetermined angle.

The P-DRM receives signals from the acceleration stroke sensor and the wheel speed sensors. At the highest level in the P-DRM, a target driving force calculation portion calculates a target driving force F1 based on the accelerator angle pap (%) and the wheel speed No (rpm) indicated by the electric signals from the acceleration stroke sensor and the wheel speed sensors, respectively.

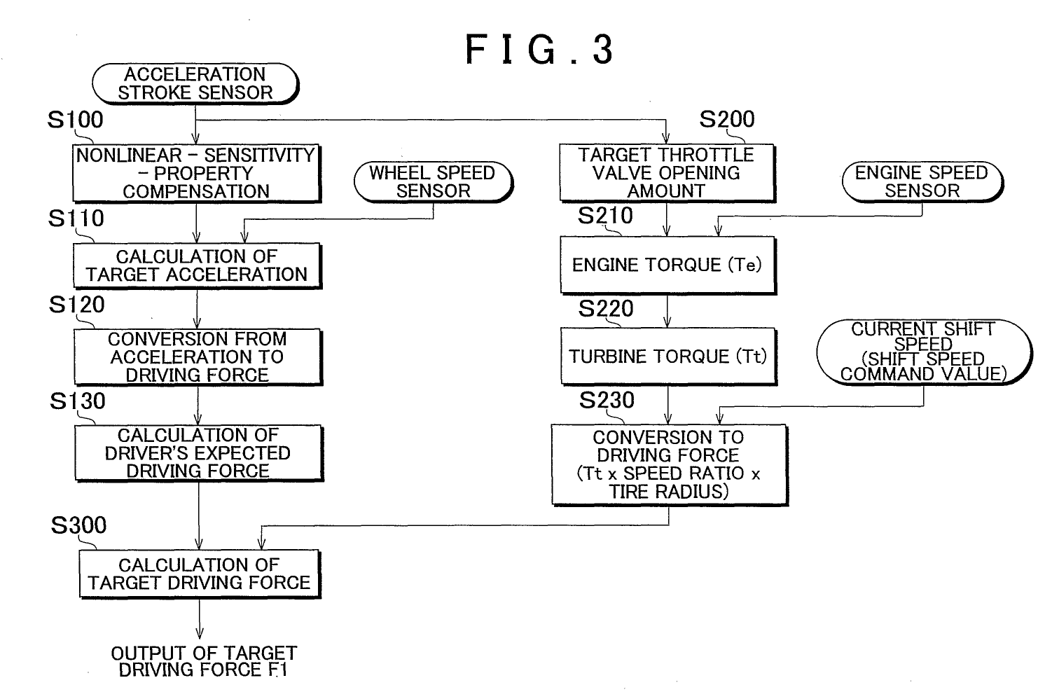

FIG. 3 illustrates the flowchart of the target driving force calculation and coordination process performed by the target driving force calculation portion of the P-DRM in FIG. 2.

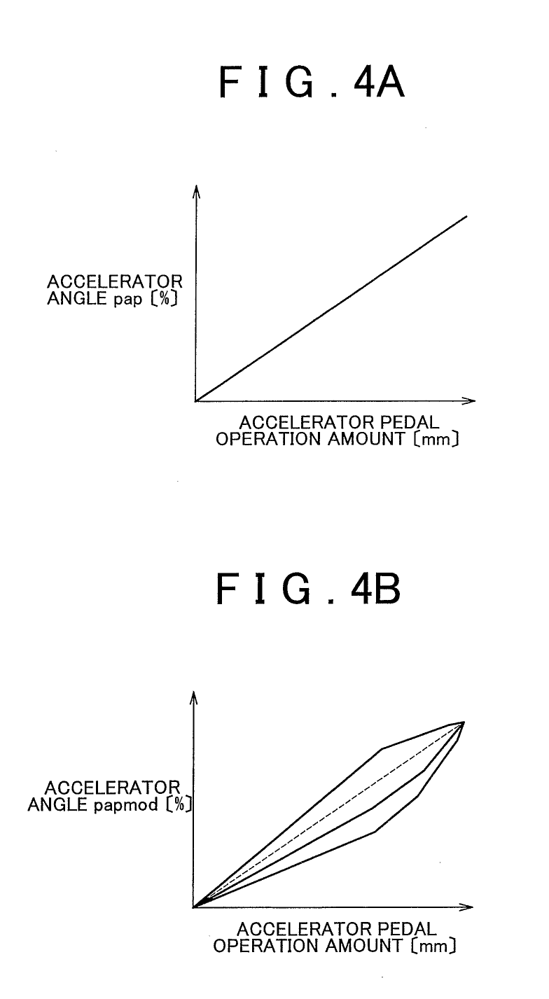

In step S100, a nonlinear-sensitivity-property compensation process is performed. The nonlinear-sensitivity-property compensation process (step 100) will be described below with reference to FIGS. 4A and 4B.

An accelerator angle pap (%) linearly increases with an increase in the operation amount of the accelerator pedal 200, as shown in FIG. 4A. Such proportional relationship does not change depending on the operating characteristics (characteristics of reaction force and stroke) of the accelerator pedal. In the nonlinear-sensitivity-property compensation process, as shown by the solid lines (indicating three types of nonlinear characteristics) in FIG. 4B, the accelerator angle pap (%) is corrected to an accelerator angle papmod (%) that non-linearly changes with respect to a change in the operation amount of the accelerator pedal 200. In other words, in the nonlinear-sensitivity- property compensation process, the parameter used in the target acceleration setting process in step S110 is set to the accelerator angle papmod (%) that differs from the accelerator angle pap (%) actually detected.

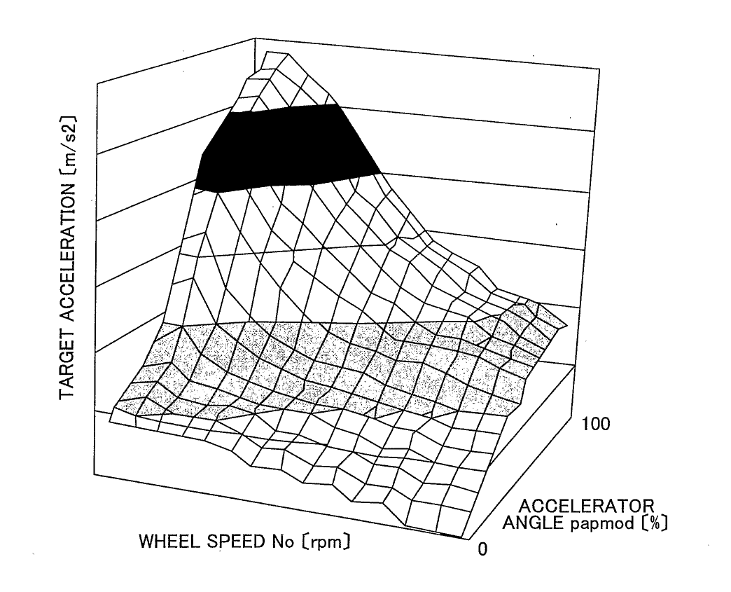

FIG. 5 illustrates an example of the three-dimensional map used in step S100. This three-dimensional map defines the relationship among the accelerator angle papmod (%), the wheel speed No. (rpm), and a target acceleration G (m/s²).

As described above, by performing the nonlinear-sensitivity-property compensation process, the target driving force calculation portion in the P-DRM corrects the accelerator angle pap (%) to the accelerator angle papmod (%) based on the correction characteristics shown in FIG. 4B. Next, the target driving force calculation portion calculates the target acceleration G (m/s²) based on the map in FIG. 5, using the accelerator angle papmod (%) and the wheel speed No (rpm) as parameters (step S110).

The target acceleration G derived in step S110 is used when the vehicle is running on a flat road where gravity components are not taken into account. This is because, although gravity components are subtracted from or added to the acceleration felt by the driver, such gravity components are offset, in actuality, based on the information visually obtained by the driver (namely, the driver feels the acceleration of the vehicle body as an acceleration feel regardless of whether the vehicle is running on a flat road or a sloping road). In other words, if the gravity components are added to the target acceleration, the driver may feel a strong acceleration feel on an uphill slope and a weak acceleration feel on a downhill slope. As a result, the driver feels a sense of discomfort.

The three-dimensional map shown in FIG. 5 is set such that the target acceleration at which the driver feels comfortable, based on the relationship between the accelerator pedal operation amount and the vehicle speed, which is felt by the driver who operates the accelerator pedal 200. When such a three-dimensional map is used, the operation concerning the vehicle speed (quick response to an acceleration operation, a snow drive mode operation, and a sport drive mode) can be performed more appropriately, in comparison to the case where the two-dimensional map that defines the relationship between the accelerator pedal operation amount and the target acceleration is used. As a result, the target acceleration at which the driver feels more comfortable can be set.

After the target acceleration G is thus set, the target driving force calculation portion converts the target acceleration G (m/s²) to the target driving force (N) (step S120). In step S130, the target driving force calculation portion, if necessary, makes an appropriate correction to the target driving force (N) derived in step S120, thereby calculating a driver's expected driving force Fdr. For example, the driver's expected driving force Fdr is calculated by correcting the target driving force (N) calculated in step S120 using an uphill-slope compensation amount (N) that is determined based on running resistance (N) and a road inclination.

Meanwhile, the target driving force calculation portion of the P-DRM performs steps 200 to 230 while performing steps S100 to S130.

First, in step S200, a target throttle valve opening amount ttahb (deg) is calculated based on the operation amount of the accelerator pedal 200.

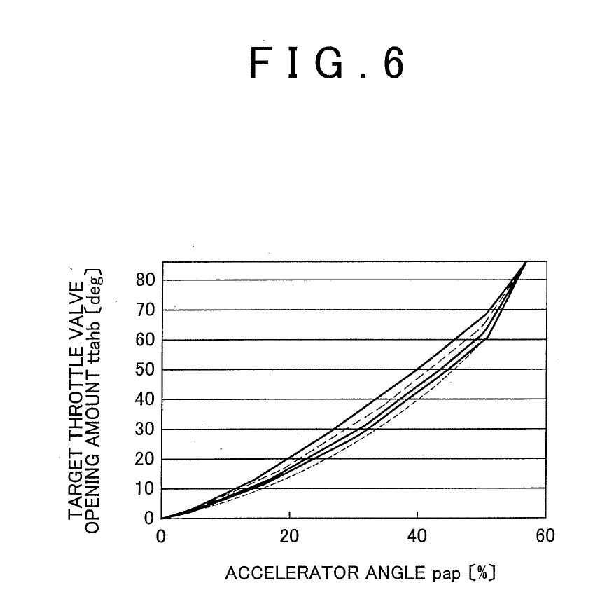

FIG. 6 illustrates an example of the map used in step S200. FIG. 6 illustrates the two-dimensional map that defines the relationship between the accelerator angle pap (%) and the target throttle valve opening amount ttahb (deg). FIG. 6 shows multiple characteristic curves. As indicated by the characteristic curves, the lines indicating the relationship between the accelerator angle pap and the target throttle valve opening amount ttahb exhibit nonlinear characteristics. The characteristic curves in the map may be defined in a commonly employed manner. The target driving force calculation portion calculates the target throttle valve opening amount ttahb (deg) based on the map as shown in FIG. 6 using the accelerator angle pap (%) as a parameter.

In step S210, an engine torque Te (Nm) is calculated (estimated) based on the target throttle valve opening amount ttahb and the engine speed (value detected by an engine speed sensor). In step S220, a turbine torque Tt (Nm) is calculated (estimated) based on the calculated engine torque Te. Each of the engine torque Te (Nm) and the turbine torque Tt (Nm) is calculated (estimated) based on a predetermined performance map (for example, the turbine torque Tt (Nm) is calculated based on the performance map showing the relationship between the engine torque Te and the turbine torque Tt).

In step S230, the target driving force is calculated by converting the turbine torque Tt calculated (estimated) in step S220 into the target driving force (N) using the current shift speed (a shift speed instructed value based on the target shift speed, described later in detail) and a radius of a tire (known data value) (hereinafter, the target driving force thus calculated will be referred to as a “throttle-based target driving force Fsl”). When the transmission 240 is a stepped transmission, the shift speed achieved before shifting is started may be used as the current shift speed during shifting, before the inertia phase, where the rotational speed changes, starts during shifting. After the inertia phase starts, the shift speed to be achieved after shifting ends may be used as the current shift speed during shifting. Alternatively, the current shift speed during shifting may be derived by calculating an estimated speed ratio based on the rotational speeds of the input shaft and the output shaft of the transmission 240 during shifting, and then performing a linear interpolation using the estimated speed ratio.

In step S300, the final target driving force F1 (N) is derived by coordinating the two target driving forces thus determined through the respective two routes, that are, the driver's expected driving force Fdr and the throttle-based target driving force Fsl with each other. Namely, the target driving force calculation portion determines the final target driving force F1 by coordinating the driver's expected driving force Fdr and the throttle-based target driving force Fsl with each other according to a predetermined coordination conditions.

According to the embodiment, the driving force demand type configuration is realized by preferentially using the driver's expected driving force Fdr, only in the situations where there is no disadvantages due to the driving force demand type configuration or where, even if there is a disadvantage, it does not cause a problem. In the other situations where the driving force demand type configuration may cause a problem, the throttle demand type configuration is realized by preferentially using the throttle-based target driving force Fsl. Therefore, a sense of discomfort felt by the driver during shifting, etc. can be reduced by appropriately using both the driving force demand type configuration and the throttle demand type configuration as the situation demands.

In the coordination process in step S300, for example, the driver's expected driving force Fdr is preferentially selected in the cases where the vehicle starts and the accelerator pedal is depressed to increase the vehicle speed while the vehicle is running. In the other cases, particularly, in the case where the vehicle is running at a constant speed, the throttle-based target driving force Fsl is preferentially selected. This is because, when the vehicle starts or when the accelerator pedal is depressed while the vehicle is running, even if a phenomenon corresponding to a further depression of the accelerator pedal during shifting occurs, it does not cause a problem because the driver is currently depressing the accelerator pedal. Alternatively, the driver's expected driving force Fdr may be preferentially selected in the case where the absolute value of the operation speed (a positive value or a negative value), at which the accelerator pedal is operated, is equal to or higher than a predetermined value. In the other cases, particularly, in the case where the vehicle is running at a constant speed, the throttle-based target driving force Fsl may be preferentially selected. Also, when it is possible to predict that the driver will operate the accelerator pedal at a speed equal to or higher than the predetermined speed, for example, when it is predicted that the vehicle will pass the ending point of a curve or the starting point of a sloping road, the state where the throttle-based target driving force Fsl is preferentially selected may be changed, at an appropriate time, to the state where the driver's expected driving force Fdr is preferentially selected.

As described so far, according to the embodiment, during the transitional period from the throttle demand type configuration to the driving force demand type configuration, namely, during the transitional period until various problems of the driving force demand type configuration are solved and an improved driving force demand type configuration is realized, the throttle-based target driving force Fsl, which is set in the manner achieved by the conventional throttle demand type configuration, is used while the driver's expected driving force Fdr is used, as appropriate. Thus, the advantages of the driving force demand type configuration can be obtained.

Also, according to the embodiment, the target driving force Fdr and the target driving force Fsl are calculated through the respective two calculation routes based on the same accelerator angle pap. Accordingly, excellent fail-safe properties can be obtained. Preferably, the upper limit guard values, expressed by the unit of driving force, of the target driving force Fdr and the target driving force Fsl (namely, the final target driving force F1) are set to further improve the fail-safe properties. For example, the upper limit guard value of the target acceleration calculated in step S110 may be set.

The signal indicating the target driving force F1 (N) thus set is transmitted to the elements at the lower levels through two signal lines extending from the target driving force calculation portion. Hereafter, these two signal lines extending from the target driving force calculation portion will be referred to as an “engine control system transmission route” and a “T/M control system transmission route”. If necessary, in each route, the target driving force F1 (N) is coordinated with the DSS instructed driving force indicated by the signal from the DSS, as shown in FIG. 2.

The DSS provides an appropriate instruction as an alternative to the input of the driver or an appropriate instruction to make a correction to the input of the driver, based on the information concerning obstacles located around the vehicle, which is captured, for example, by a camera or a radar, the road information and ambient area information obtained from a navigation system, the current position information obtained from a GPS positioning device of the navigation system, or various information obtained via communication with the operation center, vehicle-to-vehicle communication or road-to-vehicle communication. Examples of the instructions include an instruction from the DSS during the automatic cruise control or the automatic or semi-automatic running control similar to the automatic cruise control, and an instruction from the DSS while the intervention-deceleration control or steering assist control is performed, for example, to avoid an obstacle.

The signal indicating target driving force F1 (N) that has undergone necessary coordination processes is output to a power-train manager (hereinafter, referred to as a “PTM”: Power-Train Manager). The PTM is a manager that functions as an instruction coordination portion of the drive control system.

At the highest level of the PTM, the signal indicating the target driving force F1 (N) from the P-DRM is transmitted to a manager of the dynamic behavior control system (hereinafter, referred to as a “VDM”: Vehicle Dynamics Manager). The VDM is arranged at the level subordinate to a manager that functions as a driver's intention determining portion of the brake control system (hereinafter, referred to as a “B-DRM”: Brake Driver Model). The VDM is a manager that functions as a vehicle movement coordination portion. Examples of such system that stabilizes the dynamic behavior of the vehicle include a traction control system (a system that suppresses unnecessary wheelspin of the drive wheels that is likely to occur when the vehicle starts or accelerates on a slippery road), a system that suppresses a side skid that is likely to occur when the vehicle enters a slippery road, a system that stabilizes the orientation of the vehicle to prevent the vehicle from spinning out or sliding off the track if the limit of stability is reached when the vehicle is going round the curve, and a system that actively makes a difference in the driving force between the right and left rear wheels of the four-wheel drive vehicle, thereby causing a yaw moment.

At the level subordinate to the VDM, a steering control unit that controls the actuators for the front steering device 500 and the rear steering device 520, and a suspension control unit that controls the actuators for the suspensions 620 are arranged in parallel with the brake control unit that controls the actuators for the brakes 560. In the B-DRM, a target braking force calculation portion converts the electric signal transmitted from a brake sensor into a signal indicating a target braking force. This signal is then transmitted via the VDM to the brake control unit. While not described in detail in this specification, the target braking force calculated by the target braking force calculation portion undergoes various correction (coordination) processes in the same or similar manner in which the target driving force F1 undergoes correction (coordination) processes, as described later in detail. Then, the signal indicating the target braking force derived after correction (coordination) is output to the brake control unit.

The target driving force F1 is primarily determined based mainly on the input of the driver. A driving force correction portion of the VDM secondarily provides an instruction to correct the target driving force F1 to stabilize the dynamic behavior of the vehicle. Namely, the driving force correction portion of the VDM provides instructions to correct the target driving force F1, if necessary. In this case, preferably, the driving force correction portion of the VDM indicates the absolute amount of the target driving force F1 that should replace the target driving force F1, not the correction amounts ΔF by which the target driving force F1 should be increased or decreased. Hereafter, the absolute amount of the target driving force indicated by the instruction from the VDM, which is derived from the target driving force F1, will be referred to as a “target driving force F2”.

As shown in FIG. 2, a signal indicating the target driving force F2 is input in the PTM. As shown in FIG. 2, the signal indicating the target driving force F2 is input in each of the engine control system transmission route and the T/M control system transmission route. At the input portion of each route, the target driving force F2 is coordinated with the target driving force F1. In this coordination process, preferably, a higher priority is given to the target driving force F2 than to the target driving force F1, because a higher priority should be given to a stable dynamic behavior of the vehicle. Alternatively, the final target driving force may be derived by appropriately assigning weights to the target driving force F2 and the target driving force F1. To give a higher priority to the stable dynamic behavior of the vehicle, the greater weight is assigned to the target driving force F2 than to the target driving force F1. The target driving force derived through such coordination process will be referred to as a “target driving force F3”.

In the T/M control system transmission route, a signal indicating the target driving force F3, derived after such coordination process, is input in a target shift speed setting portion, as shown in FIG. 2. The target shift speed setting portion sets the final target shift speed based on a predetermined shift diagram showing the relationship between the driving force and the wheel speed No.

A signal indicating the target shift speed thus set in the PTM is output to the T/M control unit arranged at the level subordinate to the PTM. The T/M control unit controls the actuator for the transmission 240 to achieve the target shift speed indicated by the signal received.

In the engine control system transmission route, a conversion portion converts the mode of expressing the target driving force F3 from the mode where it is expressed by the driving force (N) to the mode where it is expressed by the engine torque (Nm), as shown in FIG. 2. Then, the target driving force F3 is coordinated with an instructed engine torque indicated by a signal transmitted from the T/M control unit to the PTM, and a signal indicating target driving force F3, derived after such coordination process, is output to the engine control unit arranged at the level subordinate to the PTM. The engine control unit controls the actuator for the engine 140 to achieve the target engine torque indicated by the signal from the PTM.

According to the embodiment described so far, the target driving force F1 calculated by the target driving force calculation portion of the P-DRM undergoes various correction (coordination) processes, and the signal indicating the target driving force that has undergone various correction (coordination) processes is output to the engine control unit and the T/M control unit. These control units control the actuators for the engine 140 and the transmission 240, whereby the target driving force F1 (if the target driving force F1 has undergone the coordination process, the target driving force F2 or the target driving force F3) is achieved.

In the embodiment, each coordination portion performs the coordination process using the unit of physical quantity suitable for the instruction. Because the DSS and the VDM are basically the systems that control driving force, preferably, instructions from the DSS and the VDM are provided and the coordination process are performed using the unit of driving force. According to the embodiment described above, because the target throttle valve opening amount ttahb (deg) is converted into the throttle-based target driving force Fsl and the mode of expressing the throttle valve opening amount ttahb (deg) is changed to the mode where it is expressed by the unit of driving force at the P-DRM at the highest level of the system, appropriate coordination processes suitable for the instructions can be performed. In addition, the unit of physical quantity need not be changed between when the coordination process is performed and when an instruction is provided. Also, modification of the communication software structure due to the change in the unit of physical quantity can be avoided. As a result, inefficiency caused by such change and modification can be effectively minimized.

However, such an efficient configuration is not an essential element of the invention. Instead of such an efficient configuration, the final control target may be derived in the following manner in which 1) the target throttle valve opening amount ttahb (deg) expressed by the unit of throttle valve opening amount is coordinated with the instruction values from the DSS and the VDM, and 2) the control target value, which is derived through such coordination, and the control target values (F1, F2, F3, etc.), which have undergone the similar coordination process and which are expressed by the unit of driving force, are finally coordinated with each other in the PTM. The coordination process may be performed using either the unit of driving force or the unit of throttle valve opening amount.

The embodiment of the invention that has been described in the specification is to be considered in all respects as illustrative and not restrictive. The technical scope of the invention is defined by claims, and all changes which come within the meaning and range of equivalency of the claims are therefore intended to be embraced therein.

In the embodiment, the engine 140 includes an electronic throttle valve, and is used as the power source. However, the invention may be applied to a configuration where the motor without an electronic throttle valve is used as the power source.

1. A driving force control device that is used in a vehicle including a drive source and an automatic transmission which is connected to the drive source and which changes a speed ratio in a stepwise manner or continuously, comprising:
controller that determines an accelerator angle based on an operation amount of an accelerator pedal by a driver and operating characteristics of the accelerator pedal, and sets a first target driving force based on the accelerator angle a vehicle speed;
sets a target throttle valve opening amount based on the operation amount of the accelerator pedal by the driver;
sets a second target driving force based on the target throttle valve opening amount;
sets a final target driving force by coordinating the first target driving force and the second target driving force with each other according to a predetermined coordination condition when the vehicle is running; and
controls the drive source and the automatic transmission based on the final target driving force.

2-14. (canceled)

15. The driving force control device according to claim 1, wherein
the controller determines a target acceleration based on the accelerator angle and the vehicle speed and sets the first target driving force base don the target acceleration.

16. The driving force control device according claim 1, wherein
the controller gives a higher priority to the first target driving force than to the second target driving force, thereby setting the final target driving force the first target driving force, when the vehicle starts running.

17. The driving force control device according claim 1, wherein
the controller gives a higher priority to the second target driving force than to the first target driving force, thereby setting the final target driving force to the second target driving force, when the vehicle is running at a constant speed.

18. The driving force control device according to claim 1, wherein
the controller gives a higher priority to the first target driving force than to the second target driving force, thereby setting the final target driving force to the first target driving force, when a speed at which the accelerator pedal is operated is equal to or higher than a predetermined value.

19. The driving force control device according to claim 1, wherein
the final target driving force setting means gives a higher priority to the second target driving force than to the first target driving force, thereby setting the final target driving force to the second target driving force, when the speed at which the accelerator pedal is operated is lower than a predetermined value.

20. A driving force control method employed in a vehicle including a drive source and an automatic transmission which is connected to the drive source and which changes a speed ratio in a stepwise manner or continuously, comprising:
a controller that sets a first target driving force based on an operation amount of an accelerator pedal by a driver, operating characteristics of the accelerator pedal and a vehicle speed;
sets a target throttle valve opening amount based on the operation amount of the accelerator pedal by the driver;
determines an engine torque based on the target throttle valve opening amount and an engine speed, and sets a second target driving force based on the engine torque;
sets a final target driving force by coordinating the first driving force and the second target driving force with each other according to a predetermined coordination condition when the vehicle is running; and
controls the drive source and the automatic transmission based on the final target driving force.

21. The driving force control device according to claim 20, wherein
the controller determines a target acceleration based on the accelerator angle and vehicle speed and sets the first target driving force based on the target acceleration.

22. The driving force control device according to claim 20, wherein
the controller gives a higher priority to the first target driving force than to the second target driving force, thereby setting the final target driving force to the first target driving force, when the vehicle starts running.

23. The driving force control device according to claim 20, wherein
the controller gives a higher priority to the second target driving force than to the first target driving force, thereby setting the final target driving force to the second target driving force, when the vehicle is running at a constant speed.

24. The driving force control device according to claim 20, wherein
the controller gives a higher priority to the first target driving force than to the second target driving force, thereby setting the final target driving force to the first target driving force, when a speed at which the accelerator pedal is operated is equal to or higher than a predetermined value.

25. The driving force control device according to claim 20, wherein
the controller gives a higher priority to the second target driving force than to the first target driving force, thereby setting the final target driving force to the second target driving force, when the speed at which the accelerator pedal is operated is lower than a predetermined value.

26. The driving force control method employed in a vehicle including a drive source and an automatic transmission which is connected to the drive source and which changes a speed ratio in a stepwise manner or continuously, comprising:
determining an accelerator angle based on an operation amount of an accelerator pedal by a driver and operating characteristics of the accelerator pedal, and setting a first target driving force based on the accelerator angle and vehicle speed;
setting a target throttle valve opening amount based on the operation amount of the accelerator pedal by the driver;
setting a second target driving force based on the target throttle valve opening amount;
setting a final target driving force by coordinating the first target driving force and the second target driving force with each other according to a predetermined coordination condition when the vehicle is running; and
controlling the drive source and the automatic transmission based on the final target driving force.

27. The driving force control method according to claim 26, further comprising:
determining a target acceleration based on the accelerator angle and the vehicle speed, and;
setting the first target driving force based on the target acceleration.

28. The driving force control method according to claim 26, wherein
a higher priority is given to the first target driving force than to the second target driving force, whereby the final target driving force is set to the first target driving force, when the vehicle starts running.

29. The driving force control method according to claim 26, wherein
a higher priority is given to the second target driving force than to the first target driving force, whereby the final target driving force is set to the second target driving force, when the vehicle is running at a constant speed.

30. The driving force control method according to claim 26, wherein
a higher priority is given to the first target driving force than to the second target driving force, whereby the final target driving force is set to the first target driving force, when a speed at which the accelerator pedal is operated is equal to or higher than a predetermined value.

31. The driving force control method according to claim 26, wherein
a higher priority is given to the second target driving force than to the first target driving force, whereby the final target driving force is set to the second target driving force, when the speed at which the accelerator pedal is operated is lower than a predetermined value.

32. A driving force control method employed in a vehicle including a drive source and an automatic transmission which is connected to the drive source and which changes a speed ratio in a stepwise manner or continuously, comprising:
setting a first target driving force based on an operation amount of an accelerator pedal by a driver, operating characteristics of the accelerator pedal, and a vehicle speed;
setting a target throttle valve opening amount based on the operation amount of the accelerator pedal by the driver;
determining an engine torque based on the target throttle valve opening amount and an engine speed, and setting a second target driving force based on the target acceleration;
setting a final target driving force by coordinating the first target driving force and the second target driving force with each other according to a predetermined coordination condition when the vehicle is running; and
controlling the drive source and the automatic transmission based on the final target driving force.

33. The driving force control method according to claim 32, further comprising:
determining a target acceleration based on the accelerator angle and the vehicle speed, and;
setting the first target driving force based on the target acceleration.

34. The driving force control method according to claim 32, wherein
a higher priority is given to the first target driving force than to the second target driving force, whereby the final target driving force is set to the first target driving force, when the vehicle starts running.

35. The driving force control method according to claim 32, wherein
a higher priority is given to the second target driving force than to the first target driving force, whereby the final target driving force is set to the second target driving force, when the vehicle is running at a constant speed.

36. The driving force control method according to claim 32, wherein
a higher priority is given to the first target driving force than to the second target driving force, whereby the final target driving force is set to the first target driving force, when a speed at which the accelerator pedal is operated is equal to or higher than a predetermined value.

37. The driving force control method according to claim 32, wherein
a higher priority is given to the second target driving force than to the first target driving force, whereby the final target driving force is set to the second target driving force, when the speed at which the accelerator pedal is operated is lower than a predetermined value.
